(19) United States
(12) Patent Application Publication
(10) Pub. No.: US 2026/0323081 A1
(43) Pub. Date: Oct. 15, 2026

(54) ADAPTIVE EXTRAPOLATED FILTER-BASED INTRA PREDICTION USING RECONSTRUCTED INFORMATION

(71) Applicant: Tencent America LLC, Palo Alto, CA (US)

(72) Inventors: Biao WANG, San Jose, CA (US); Roman CHERNYAK, Santa Clara, CA (US); Yonguk YOON, Palo Alto, CA (US); Lien-Fei CHEN, Palo Alto, CA (US); Yifan WANG, Palo Alto, CA (US); Shan LIU, San Jose, CA (US); Ziyue XIANG, Palo Alto, CA (US)

(73) Assignee: Tencent America LLC, Palo Alto, CA (US)

(21) Appl. No.: 19/467,499

(22) Filed: Feb. 2, 2026

Related U.S. Application Data
(60) Provisional application No. 63/779,190, filed on Mar. 27, 2025.

(51) Int. Cl. H04N 19/593; H04N 19/176; H04N 19/82

(52) U.S. Cl. CPC H04N 19/593; H04N 19/176; H04N 19/82

(57) ABSTRACT

A method for video decoding includes selecting a set of filter shapes from a plurality of sets of filter shapes associated with extrapolated filter-based intra prediction based on reconstructed information of a current block. The plurality of sets of filter shapes includes a first set of filter shapes and a second set of filter shapes. The method includes predicting, based on the selected set of filter shapes, a current sample in the current block using the extrapolated filter-based intra prediction. The first set of filter shapes only includes above-left positions that are above and to the left of a current position of the current sample. The second set of filter shapes includes one or more of (i) above-right positions that are above and to the right of the current position and (ii) below-left positions that are below and to the left of the current position.

### RELATED APPLICATION

The present application claims the benefit of priority to U.S. Provisional Application No. 63/779,190, “ADAPTIVE EXTRAPOLATED FILTER-BASED INTRA PREDICTION USING RECONSTRUCTED INFORMATION” filed on Mar. 27, 2025, which is incorporated by reference herein in its entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

### SUMMARY

Aspects of the disclosure provide a method for video decoding. The method for video decoding includes receiving a bitstream including coded information indicating that a current block is coded with extrapolated filter-based intra prediction. The method includes selecting a set of filter shapes from a plurality of sets of filter shapes associated with the extrapolated filter-based intra prediction based on reconstructed information of the current block. The plurality of sets of filter shapes includes a first set of filter shapes and a second set of filter shapes. The method includes predicting, based on the selected set of filter shapes, a current sample in the current block using the extrapolated filter-based intra prediction. The first set of filter shapes only includes above-left positions that are above and to the left of a current position of the current sample. The second set of filter shapes includes one or more of (i) above-right positions of the current position of the current sample and (ii) below-left positions of the current position of the current sample. The above-right positions are above and to the right of the current position and the below-left positions are below and to the left of the current position.

Aspects of the disclosure also provide an apparatus for video decoding. The apparatus for video decoding includes processing circuitry configured to implement any of the described methods for video decoding.

Aspects of the disclosure also provide a method for video encoding. The method of video encoding includes selecting a set of filter shapes from a plurality of sets of filter shapes associated with extrapolated filter-based intra prediction based on reconstructed information of a current block that is encoded using the extrapolated filter-based intra prediction. The plurality of sets of filter shapes includes a first set of filter shapes and a second set of filter shapes. The method includes predicting, based on the selected set of filter shapes, a current sample in the current block using the extrapolated filter-based intra prediction. The method includes encoding a bitstream including information indicating that the current block is encoded with the extrapolated filter-based intra prediction. The first set of filter shapes only includes above-left positions that are above and to the left of a current position of the current sample. The second set of filter shapes includes one or more of above-right positions of the current position of the current sample and below-left positions of the current position of the current sample. The above-right positions are above and to the right of the current position. The below-left positions are below and to the left of the current position.

Aspects of the disclosure also provide an apparatus for video encoding. The apparatus for video encoding includes processing circuitry configured to implement any of the described methods for video encoding.

Aspects of the disclosure also provide a non-transitory computer-readable storage medium storing instructions which when executed by a processor cause the processor to perform a method of encoding a bitstream including: selecting a set of filter shapes from a plurality of sets of filter shapes associated with extrapolated filter-based intra prediction based on reconstructed information of a current block that is encoded using the extrapolated filter-based intra prediction. The plurality of sets of filter shapes includes a first set of filter shapes and a second set of filter shapes. The method includes predicting, based on the selected set of filter shapes, a current sample in the current block using the extrapolated filter-based intra prediction. The method includes encoding the bitstream including information indicating that the current block is encoded with the extrapolated filter-based intra prediction. The bitstream is transmitted. The first set of filter shapes only includes above-left positions that are above and to the left of a current position of the current sample. The second set of filter shapes includes one or more of above-right positions of the current position of the current sample and below-left positions of the current position of the current sample. The above-right positions are above and to the right of the current position. The below-left positions are below and to the left of the current position

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of intra prediction modes including directional prediction modes, a planar mode, and a DC mode according to an aspect of the disclosure.

FIG. 5 shows an example of a first set of filter shapes according to an aspect of the disclosure.

FIG. 6 shows an example of three templates having different shapes of a current block according to an aspect of the disclosure.

FIGS. 7-9 show an example of predicting samples in a current block based on extrapolated filter-based intra prediction according to an aspect of the disclosure.

FIG. 10 shows an example of a scanning order used to predict samples at different positions in a current block according to an aspect of the disclosure.

FIG. 11 shows an example of a second set of filter shapes according to an aspect of the disclosure.

FIG. 12 shows an example of determining gradient information of a template of a current block in a current picture according to an aspect of the disclosure.

FIG. 13 shows an example of a scanning order used to predict samples at different positions in a current block according to an aspect of the disclosure.

FIG. 14 shows an example of a scanning order that is used to determine a filter model according to an aspect of the disclosure.

FIG. 15 shows a flow chart outlining a decoding process according to some aspects of the disclosure.

FIG. 16 shows a flow chart outlining a process according to an aspect of the disclosure.

FIG. 17 is a schematic illustration of a computer system in accordance with an aspect.

### DETAILED DESCRIPTION

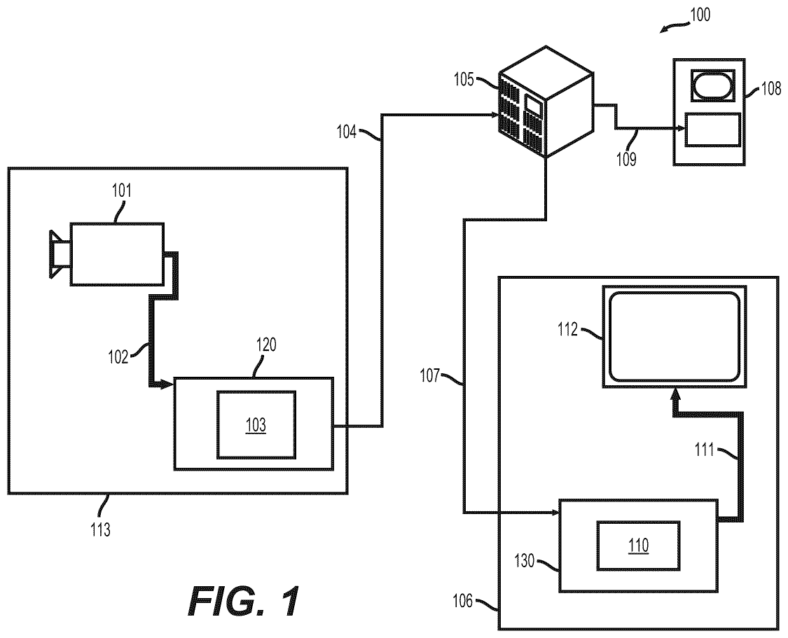

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other video enabled applications, including, for example, video conferencing, digital TV, streaming services, storing of compressed video on digital media including CD, DVD, memory stick and the like, and so on.

The video processing system (100) includes a capture subsystem (113), that may include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) may be encoded according to certain video coding/compression standards. Examples of those standards include ITU-T Recommendation H.265 and Versatile Video Coding (VVC). The disclosed subject matter may be used in the context of VVC.

It is noted that the electronic devices (120) and (130) may include other components (not shown). For example, the electronic device (120) may include a video decoder (not shown) and the electronic device (130) may include a video encoder (not shown) as well.

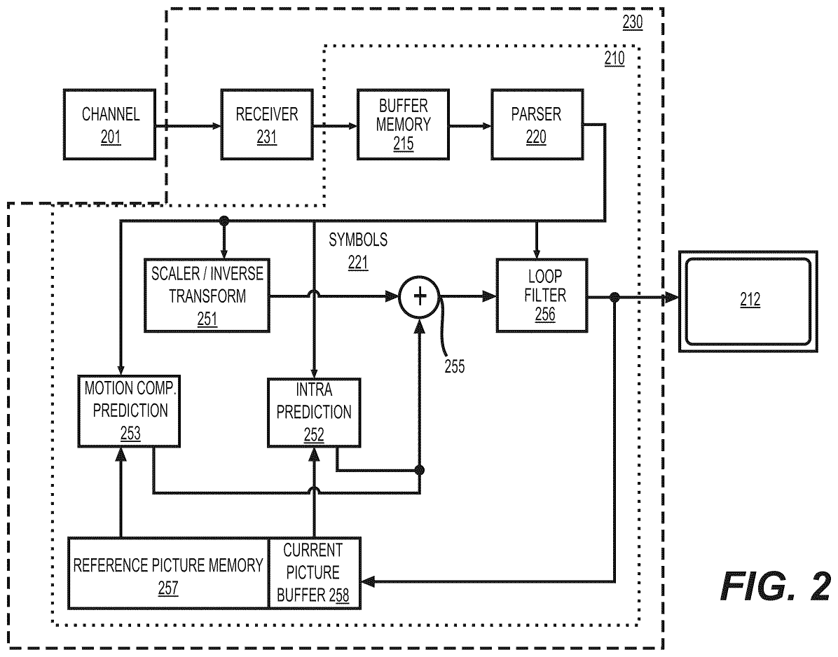

FIG. 2 shows an example of a block diagram of a video decoder (210). The video decoder (210) may be included in an electronic device (230). The electronic device (230) may include a receiver (231) (e.g., receiving circuitry). The video decoder (210) may be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it may be outside of the video decoder (210) (not depicted). In still others, there may be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or may be small. For use on best effort packet networks such as the Internet, the buffer memory (215) may be required, may be comparatively large and may be advantageously of adaptive size, and may partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but may be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence may be in accordance with a video coding technology or standard, and may follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups may include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) may involve multiple different units depending on the type of the coded video picture or parts thereof (such as: inter and intra picture, inter and intra block), and other factors. Which units are involved, and how, may be controlled by subgroup control information parsed from the coded video sequence by the parser (220). The flow of such subgroup control information between the parser (220) and the multiple units below is not depicted for clarity.

Beyond the functional blocks already mentioned, the video decoder (210) may be conceptually subdivided into a number of functional units as described below. In a practical implementation operating under commercial constraints, many of these units interact closely with each other and may, partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) may output blocks comprising sample values, that may be input into aggregator (255).

In some cases, the output samples of the scaler/inverse transform unit (251) may pertain to an intra coded block. The intra coded block is a block that is not using predictive information from previously reconstructed pictures, but may use predictive information from previously reconstructed parts of the current picture. Such predictive information may be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) may pertain to an inter coded, and potentially motion compensated, block. In such a case, a motion compensation prediction unit (253) may access reference picture memory (257) to fetch samples used for prediction. After motion compensating the fetched samples in accordance with the symbols (221) pertaining to the block, these samples may be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples may be controlled by motion vectors, available to the motion compensation prediction unit (253) in the form of symbols (221) that may have, for example X, Y, and reference picture components. Motion compensation also may include interpolation of sample values as fetched from the reference picture memory (257) when sub-sample exact motion vectors are in use, motion vector prediction mechanisms, and so forth.

The output samples of the aggregator (255) may be subject to various loop filtering techniques in the loop filter unit (256). Video compression technologies may include in-loop filter technologies that are controlled by parameters included in the coded video sequence (also referred to as coded video bitstream) and made available to the loop filter unit (256) as symbols (221) from the parser (220). Video compression may also be responsive to meta-information obtained during the decoding of previous (in decoding order) parts of the coded picture or coded video sequence, as well as responsive to previously reconstructed and loop-filtered sample values.

The output of the loop filter unit (256) may be a sample stream that may be output to the render device (212) as well as stored in the reference picture memory (257) for use in future inter-picture prediction.

Certain coded pictures, once fully reconstructed, may be used as reference pictures for future prediction. For example, once a coded picture corresponding to a current picture is fully reconstructed and the coded picture has been identified as a reference picture (by, for example, the parser (220)), the current picture buffer (258) may become a part of the reference picture memory (257), and a fresh current picture buffer may be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile may select certain tools as the only tools available for use under that profile from all the tools available in the video compression technology or standard. Also necessary for compliance may be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels may, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data may be in the form of, for example, temporal, spatial, or signal noise ratio (SNR) enhancement layers, redundant slices, redundant pictures, forward error correction codes, and so on.

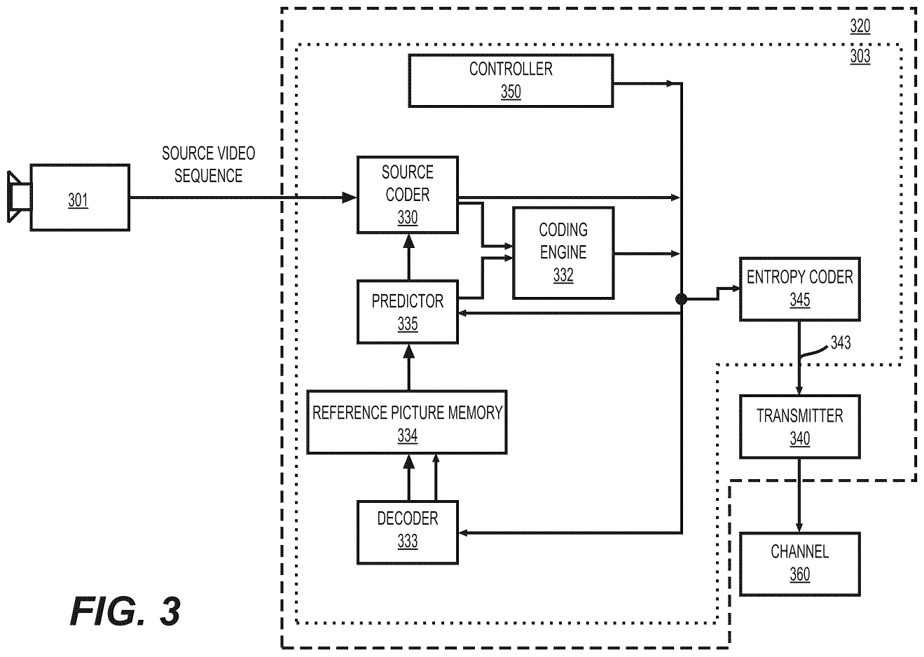

FIG. 3 shows an example of a block diagram of a video encoder (303). The video encoder (303) is included in an electronic device (320). The electronic device (320) includes a transmitter (340) (e.g., transmitting circuitry). The video encoder (303) may be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that may be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel may include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) may include rate control related parameters (picture skip, quantizer, lambda value of rate-distortion optimization techniques, . . . ), picture size, group of pictures (GOP) layout, maximum motion vector search range, and so forth. The controller (350) may be configured to have other suitable functions that pertain to the video encoder (303) optimized for a certain system design.

In some aspects, the video encoder (303) is configured to operate in a coding loop. As an oversimplified description, in an example, the coding loop may include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) may be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies may be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures may use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture may be coded by a vector that is referred to as a motion vector. The motion vector points to the reference block in the reference picture, and may have a third dimension identifying the reference picture, in case multiple reference pictures are in use.

In some aspects, a bi-prediction technique may be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture may be coded by a first motion vector that points to a first reference block in the first reference picture, and a second motion vector that points to a second reference block in the second reference picture. The block may be predicted by a combination of the first reference block and the second reference block.

Further, a merge mode technique may be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU may be recursively quadtree split into one or multiple coding units (CUs). For example, a CTU of 64×64 pixels may be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) may be implemented using any suitable technique. In an aspect, the video encoders (103) and (303) and the video decoders (110) and (210) may be implemented using one or more integrated circuits. In another aspect, the video encoders (103) and (303), and the video decoders (110) and (210) may be implemented using one or more processors that execute software instructions.

Video coding has been widely used in many applications such as broadcasting, video recording, video streaming, and the like. Various video coding standards such as H.264, H.265/HEVC, H.266/VVC, AV1, AVS, and the like have been adopted. A video codec may include various modules, including, for example, intra prediction, inter prediction, transform coding, quantization, entropy coding, in-loop filtering, and the like.

Intra prediction may be used in video coding. Intra prediction techniques may include the DC and planar modes such as used in HEVC and VVC, additional finer-granularity angular prediction with more angles compared to HEVC (e.g., a number of angular prediction modes may be used increased from 33 in HEVC to 93), additional matrix-based prediction modes for a luma component, and cross-component prediction modes for a chroma component. The new (e.g., additional) intra coding tools such as used in VVC may include: 67 intra mode with wide angles mode extension; block size and mode dependent 4 tap interpolation filter; position dependent intra prediction combination (PDPC); cross component linear model (CCLM) intra prediction; multi-reference line (MRL) intra prediction; intra sub-partitions (ISP); and weighted intra prediction with matrix multiplication.

In an example, intra mode coding with 67 intra prediction modes is described as follows. To capture the arbitrary edge directions presented in a natural video, the number of directional intra modes such as used in VVC is extended from 33 as used in HEVC to 65. The new directional modes that are not in HEVC are depicted as dotted arrows in FIG. 4, and the planar and DC modes remain the same. The denser directional intra prediction modes may apply for various block sizes (e.g., all block sizes) and for both luma and chroma intra predictions.

A current coding block (also interchangeably referred to as a current block) in a current picture and its neighboring samples in the current picture may share similar texture characteristics. In an aspect, the current coding block and the neighboring samples of the current block are in a current picture. Texture characteristics of an area (e.g., the current block, the area covering the neighboring samples of the current block) in the current picture may include smoothness of the area, a number of edges of the area, directional information of the area, and the like. For example, when a number of edges increases in the current block, the current block is considered less smooth, and thus the smoothness of the current block reduces. Directional information may indicate one or more directions that are dominant (e.g., occur most frequently) in the area.

In an aspect, a template (or a current template) of the current coding block includes neighboring reconstructed samples of the current coding block. In an example, the current coding block is being coded (e.g., being encoded or decoded), and the neighboring samples of the current coding block that are in the current template are already reconstructed. The neighboring reconstructed samples in the current template may be employed to predict the current coding block. In some examples, intra prediction (e.g., conventional intra prediction) includes angular intra prediction modes and non-angular intra prediction modes, such as shown in FIG. 4. These angular intra prediction modes and non-angular intra prediction modes may exploit the directional or non-directional texture correlation between neighboring samples, including, for example, (i) the samples in the current block and (ii) the neighboring samples of the current block.

In some examples, extrapolated filter-based intra prediction is an intra prediction mode that exploits correlation of neighboring samples by, for example, learning a model from the current template that includes the neighboring samples of the current block. In an example, an extrapolation filter is used in the extrapolated filter-based intra prediction. In an example, the extrapolation filter is an N-tap filter such as a 15-tap filter including 14 inputs and 1 output is used in the extrapolated filter-based intra prediction. The extrapolated filter-based intra prediction may use a filter having any suitable number of taps. In an example, N is an integer larger than 1.

In an example, the extrapolated filter-based intra prediction is performed as below. The filter coefficients of the N-tap filter may be obtained from the current template including the neighboring reconstructed pixels (or samples) of the current block. The extrapolation may generate a predicted value position by position, for example, from a top-left sample to a bottom-right sample within the current block.

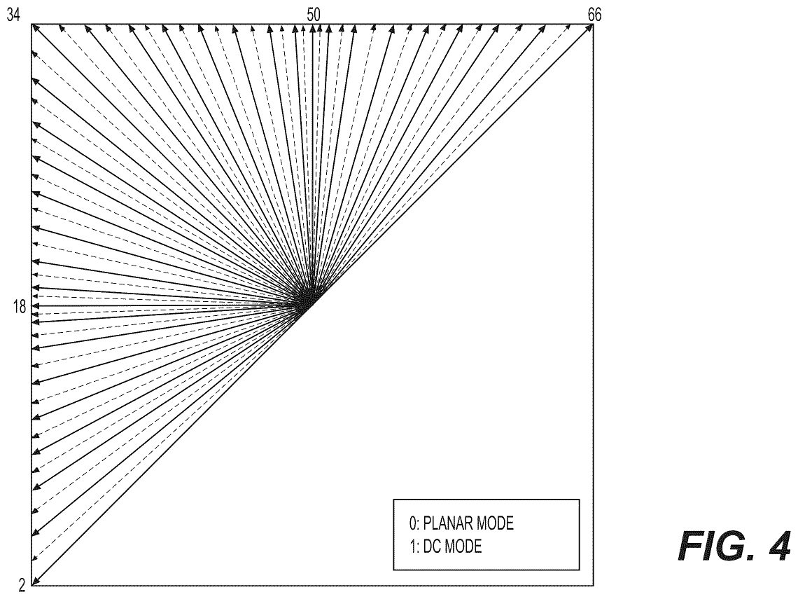

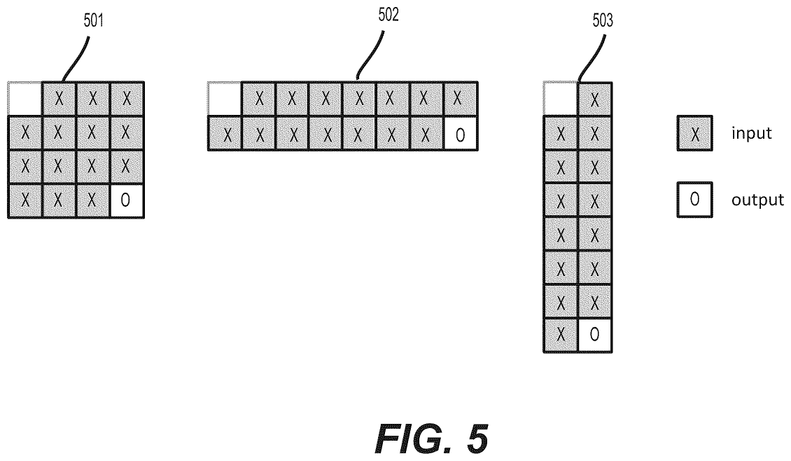

The N-tap filter (e.g., the 15-tap filter) may have different shapes. FIG. 5 shows examples of a first set of filter shapes that the filter may use according to an aspect of the disclosure. In an example, the first set of filter shapes includes three types of filter shapes (501)-(503). The three types of filter shapes (501)-(503) may include a plurality of inputs (also referred to as input samples) (e.g., fifteen inputs) labeled as “X” and generate one output labeled as “O”. In an example, the output is a prediction signal of the current sample.

As shown in FIG. 5, an extrapolation filter (e.g., the 15-tap filter) may have different shapes. The filter shape (501) is a square filter shape, which is denoted as S₀. In an example, a width (e.g., 4 samples) of S₀ is the same as a height (e.g., 4 samples) of S₀. In an example, a width (e.g., 8 samples) of H₀ is larger than a height (e.g., 2 samples) of H₀. In an example, a width (e.g., 2 samples) of V₀ is less than a height (e.g., 8 samples) of V₀.

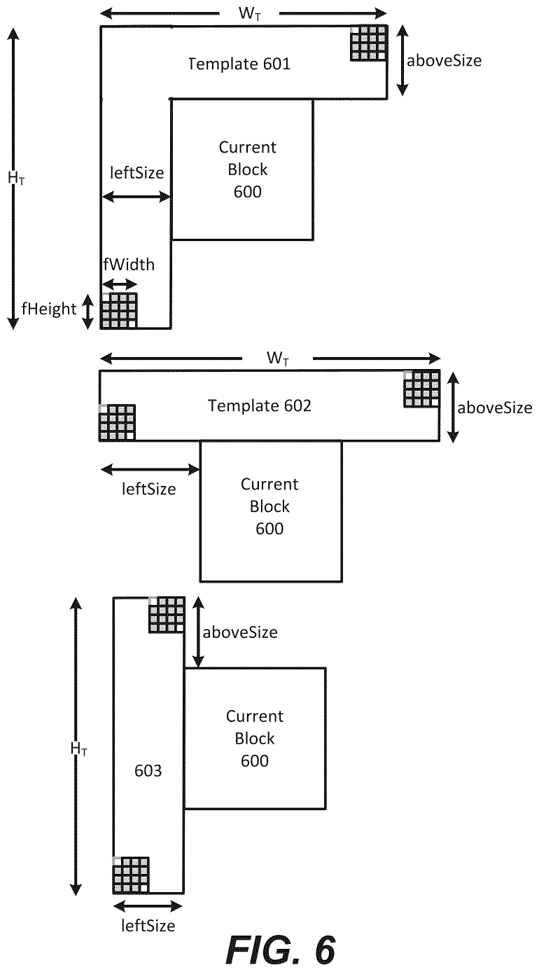

The current template used in the extrapolation filter may have different shapes, for example, a shape of the current template is selected from a plurality of template shapes, such as shown in FIG. 6. FIG. 6 shows examples of three templates or different reconstructed areas (601)-(603) of a current block (600) corresponding to three different shapes, respectively, according to an aspect of the disclosure. The three reconstructed areas (601)-(603) may include any suitable number of columns and/or rows of reconstructed samples. The reconstructed area or the template (601) has an “L” shape and includes reconstructed samples that are above and/or to the left of the current block (600). The reconstructed area or the template (602) has a rectangular shape and includes reconstructed samples that are above the current block (600). The reconstructed area or the template (602) is also referred to as a top template. The reconstructed area or the template (603) has a rectangular shape and includes reconstructed samples that are to the left of the current block (600). The reconstructed area or the template (603) is also referred to as a left template. In an example, the reconstructed area or the template (601) includes both the top template and the left template.

The current template may have any suitable size. In an example, referring to FIG. 6, a height of a portion of the template (601) that is above the current block, a height of the template (602), and a height of a portion of the template (603) that is above the current block are denoted as “aboveSize”. A width of a portion of the template (601) that is to the left of the current block (600), a width of a portion of the template (602) that is to the left of the current block (600), and a width of the template (603) are denoted as “leftSize”.

W_{CB} is a width of the current block (600), and H_{CB} is a height of the current block (600). In an example, a width WT of the portion of the template (601) that is above the current block is 2×leftSize+W_{CB}, and the portion of the template (601) that is above the current block is centered with respect to the current block (600). In an example, a height H_{T} of the portion of the template (601) that is to the left of the current block is 2×aboveSize+H_{CB}, and the portion of the template (601) that is to the left of the current block (600) is centered with respect to the current block (600).

In an example, the width WT of the template (602) is 2×leftSize+W_{CB}, and the template (602) is centered with respect to the current block (600).

In an example, the height H_{T} of the template (603) is 2×aboveSize+H_{CB}, and the template (603) is centered with respect to the current block (600).

In some examples, for a specific filter shape (e.g., one of the filter shapes (501)-(503)), three different reference areas of reconstructed samples (e.g., the templates (601)-(603)) may be chosen to learn the model. FIG. 6 shows an example of the three templates (601)-(603) where a variation of the square filter shape (501) is applied.

Learning the filter model may include obtaining the filter coefficients of the N-tap filter. In an example, the filter model includes the filter coefficients. In an example, filter coefficients are calculated using the reconstructed samples in the template (e.g., one of the templates (601)-(603)) of the current block (600).

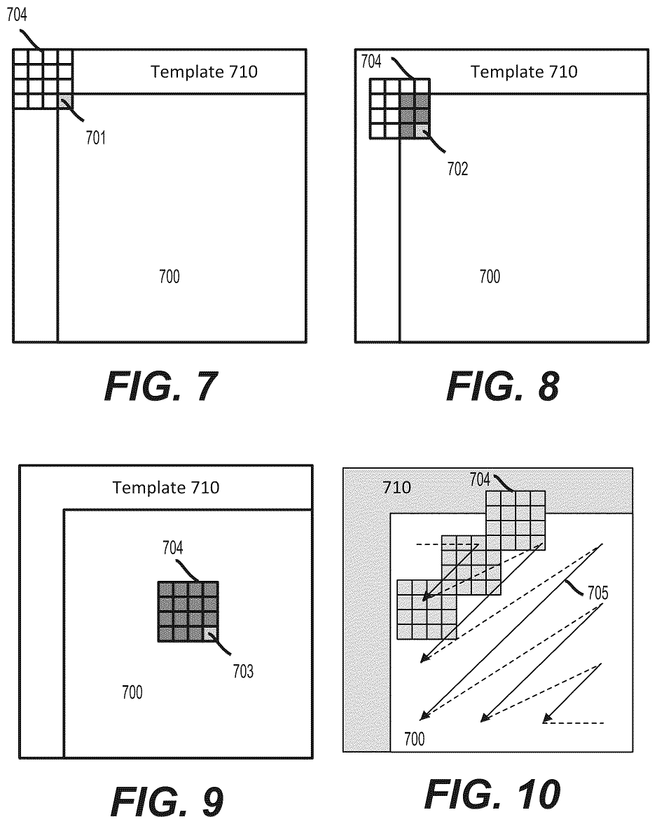

To apply the learned filter model, samples within the current coding block may be generated one-by-one from a top-left position of the current coding block to a bottom-right position of the current coding block by a diagonal prediction order, as shown in FIGS. 7-10. When applying the extrapolation filter, reconstructed sample(s) from the template of the current block and/or predicted sample(s) from the current block may be used as input samples to the extrapolation filter.

FIGS. 7-9 show an example of predicting samples in a current block (700) based on the extrapolated filter-based intra prediction according to an aspect of the disclosure. The extrapolated filter-based intra prediction may predict samples in the current block position by position.

Referring to FIG. 7, all inputs to the extrapolation filter (704) are reconstructed samples in a template (710) of the current block (700) when predicting a sample at the position (e.g., a top-left position) (701) located at the top-left of the current block (700). The inputs to the extrapolation filter are reconstructed samples in the template (710).

Referring to FIG. 8, for the positions such as a position (702) located along the boundaries of the current block (700), partial inputs to the extrapolation filter (704) are samples that have already been reconstructed in the template (710), and partial inputs (marked in gray) to the extrapolation filter are previously predicted samples (e.g., the sample (701)) in the current block (700). Referring to FIG. 8, the input samples of the extrapolation filter include reconstructed samples from the template (710) and the previously predicted samples from the current block (700).

Referring to FIG. 9, all inputs to the extrapolation filter (704) are previously predicted samples in the current block (700), for example, for other positions such as a position (703) in the current block (700), the inputs to the extrapolation filter may include the previously predicted samples in the current block (700).

As shown in FIGS. 7-9, the extrapolation filter may slide in the template (710) and/or the current block (700) with a one-sample step to collect input samples and output samples of the extrapolation filter.

In an example, to reduce the prediction error, an output range of each predicted value is restricted as described in Eq. 1.

$${pred}_{( x , y )} = clip ( min , max , ( {\sum }_{i = 0}^{n} ( {c}_{i} \times ( {t}_{( x - xoffset \_ i , y - yoffset \_ i )} - mean ) ) ) + mean ) \qquad Eq . 1$$

pred_{(x,y)} is the predicted value at (x, y) in the current block (700), min, max are searched min and max values from, for example, the template (710), cᵢ represent the i^{th} coefficient of the derived extrapolation filter, t_{(x-xoffset_i,y-yoffset_i)} is reconstructed or a predicted value used to predict the current sample, and mean is a mean value calculated, for example, by the DC prediction mode.

When the current block uses the extrapolated filter-based intra prediction, the decoder may decode the relevant syntax elements to determine the selected type of the template (e.g., which of the templates (601)-(603)) and the filter shape (e.g., which of the filter shapes (501)-(503)) for the current block.

FIG. 10 shows an example of generating predictions for different positions in the current block (700) by a diagonal order (705).

In some examples, with a fixed set of filter shapes and templates, such as the 3 filter shapes shown in FIG. 5 and the 3 template shapes shown in FIG. 6, 9 different combinations of the filter shapes and the template shapes are available to be selected, for example, by an encoder. In some examples, the training data in the template may be diverse and hence the trained model is not accurate, and a single model of the extrapolate based-filter intra prediction may generate a sub-optimal predictor. Thus, increasing a number of filter shapes may increase a diversity of the filter shapes, and allowing more combinations of the filter shapes and the template shapes that are available to be selected, and may generate a more accurate filter model and thus resulting in a more accurate prediction signal.

According to an aspect of the disclosure, one or more sets of filter shapes and/or templates may be applied to generate a prediction signal of the current block. In some examples, the selection of the filter shape and/or the template is adaptively selected based on the available reconstructed information of the current block.

In an aspect, a set of filter shapes is selected from a plurality of sets of filter shapes associated with extrapolated filter-based intra prediction based on reconstructed information of a current block that is encoded using the extrapolated filter-based intra prediction. The plurality of sets of filter shapes includes a first set of filter shapes and a second set of filter shapes.

In some examples, a current sample in the current block is being predicted. The first set of filter shapes only includes above-left positions that are above and to the left of a current position of the current sample that is being predicted. An example of the first set of filter shapes is shown in FIG. 5 where the first set of filter shapes includes the filter shapes (501)-(503). The current position in FIG. 5 is marked with “O”.

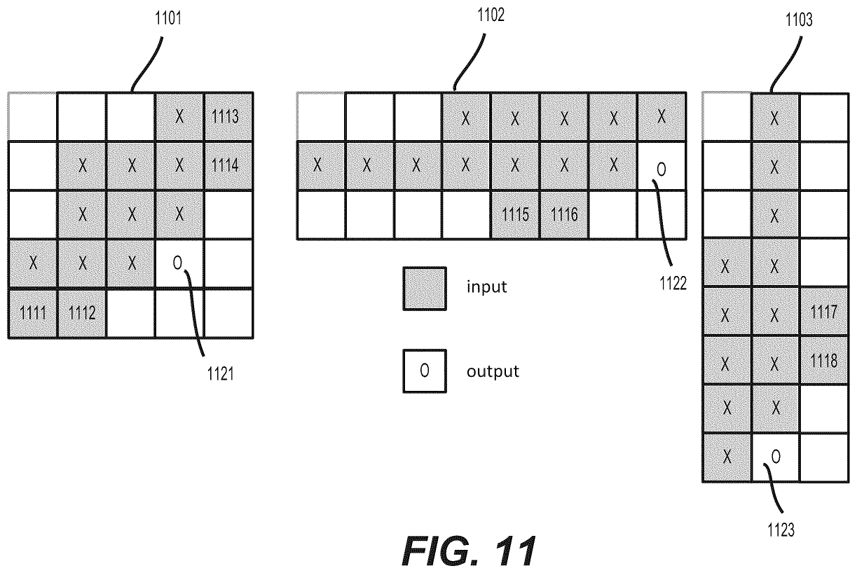

FIG. 11 shows an example of the second set of filter shapes (1101)-(1103) according to an aspect of the disclosure. The filter shapes (1101)-(1103) correspond to respective variations of the filter shapes (501)-(503).

In an example, a width and a height of each square filter shape are the same, and the filter shapes (501) and (1101) are square filter shapes. Referring to FIG. 5, the width and the height of the square filter shape (501) are the same, such as 4 samples. Referring to FIG. 11, the width and the height of the square filter shape (1101) are the same, such as 5 samples. The filter shape (1101) is a variation of the filter shape (501).

In an example, a width of each horizontal filter shape is larger than a height of the respective horizontal filter shape, and the filter shapes (502) and (1102) are horizontal filter shapes. Referring to FIG. 5, the width (e.g., 8 samples) of the filter shape (502) is larger than the height (e.g., 2 samples) of the filter shape (502). Referring to FIG. 11, the width (e.g., 8 samples) of the filter shape (1102) is larger than the height (e.g., 3 samples) of the filter shape (1102). The filter shape (1102) is a variation of the filter shape (502).

In an example, a width of each vertical filter shape is less than a height of the respective vertical filter shape, and the filter shapes (503) and (1103) are vertical filter shapes. Referring to FIG. 5, the width (e.g., 2 samples) of the filter shape (503) is less than the height (e.g., 8 samples) of the filter shape (503). Referring to FIG. 11, the width (e.g., 3 samples) of the filter shape (1103) is less than the height (e.g., 8 samples) of the filter shape (1103). The filter shape (1103) is a variation of the filter shape (503).

In some examples, the second set of filter shapes (1101)-(1103) includes one or more of (i) above-right positions of the current position of the current sample and (ii) below-left positions of the current position of the current sample. In an example, the above-right positions are above and to the right of the current position. In an example, the below-left positions are below and to the left of the current position.

Referring to FIG. 11, the filter shape (1101) includes (i) above-right positions (1113)-(1114) of the current position (1121) of the current sample and (ii) below-left positions (1111)-(1112) of the current position (1111) of the current sample. In an example, the above-right positions (1113)-(1114) are above and to the right of the current position (1121). In an example, the below-left positions (1111)-(1112) are below and to the left of the current position (1121). In the example shown in FIG. 11, in addition to the samples (1111)-(1114), the filter shape (1101) includes 10 other positions labeled with “X”, and thus the filter has 14 inputs and 1 output and is a 15-tap filter.

The filter shape (1102) includes below-left positions (1115)-(1116) of the current position (1112) of the current sample, and the below-left positions (1115)-(1116) are below and to the left of the current position (1122). In the example shown in FIG. 11, in addition to the samples (1115)-(1116), the filter shape (1102) includes 12 other positions labeled with “X”, and thus the filter has 14 inputs and 1 output and is a 15-tap filter.

The filter shape (1103) includes above-right positions (1117)-(1118) of the current position (1123) of the current sample. In an example, the above-right positions (1117)-(1118) are above and to the right of the current position (1123). In the example shown in FIG. 11, in addition to the samples (1117)-(1118), the filter shape (1103) includes 12 other positions labeled with “X”, and thus the filter has 14 inputs and 1 output and is a 15-tap filter.

The current sample (e.g., at the current position (1121), (1122), or (1123)) in the current block is predicted, based on the selected set of filter shapes, using the extrapolated filter-based intra prediction.

In an example, a bitstream is encoded including information indicating that the current block is encoded with the extrapolated filter-based intra prediction.

As described in the example shown in FIG. 11, a variation (e.g., one of (1101)-(1103)) of the square filter (e.g., (501)), the horizontal filter (e.g., (502)) and the vertical filter (e.g., (503)) in FIG. 5 may be correspondingly applied to predict the current sample. The additional filter shapes (1101)-(1103) allow samples (e.g., (1111)-(1118)) from the bottom left and/or the right top of the current sample as the input samples in the extrapolation filter. For the convenience of description, the filter shapes (1101)-(1103) of the three filters are denoted as S₁, H₁, and V₁, respectively.

In an example, the selected set of filter shapes includes multiple filter shapes. The coded information includes a first syntax element indicating which filter shape in the multiple filter shapes is to be used in the extrapolated filter-based intra prediction. The current sample in the current block is predicted based on the filter shape in the multiple filter shapes of the selected set of filter shapes and using the extrapolated filter-based intra prediction.

In an example, a syntax (e.g., the first syntax element) is signaled in the bitstream to indicate a square filter (e.g., a square filter shape) is used. The square filter shape may be (i) S₀ or (501) or (ii) S₁ or (1101). When generating the prediction signal of the current sample, the filter shape of S₀ or S₁ is determined implicitly based on the available reconstructed information.

When the bitstream signals which of the square filter shape, the horizontal filter shape, or the vertical filter shape is used, the decoder implicitly selects the variation (0 or 1) based on the reconstructed information, such as the gradient direction, without additional syntax.

In an example, a syntax (e.g., the first syntax element) is signaled in the bitstream to indicate a horizontal filter (e.g., a horizontal filter shape) is used. The horizontal filter shape may be (i) H₀ or (502) or (ii) H₁ or (1102). When generating the prediction signal of the current sample, which variation of the horizontal filter shape is used (e.g., whether the filter shape is H₀ or H₁) is determined implicitly based on the available reconstructed information, for example, when the horizontal filter is signaled to be used.

In an example, a syntax (e.g., the first syntax element) is signaled in the bitstream to indicate a vertical filter (e.g., a vertical filter shape) is used. The vertical filter shape may be (i) V₀ or (503) or (ii) V₁ or (1103). When generating the prediction signal of the current sample, whether the filter shape is V₀ or V₁ is determined implicitly based on the available reconstructed information, for example, when the vertical filter is signaled to be used.

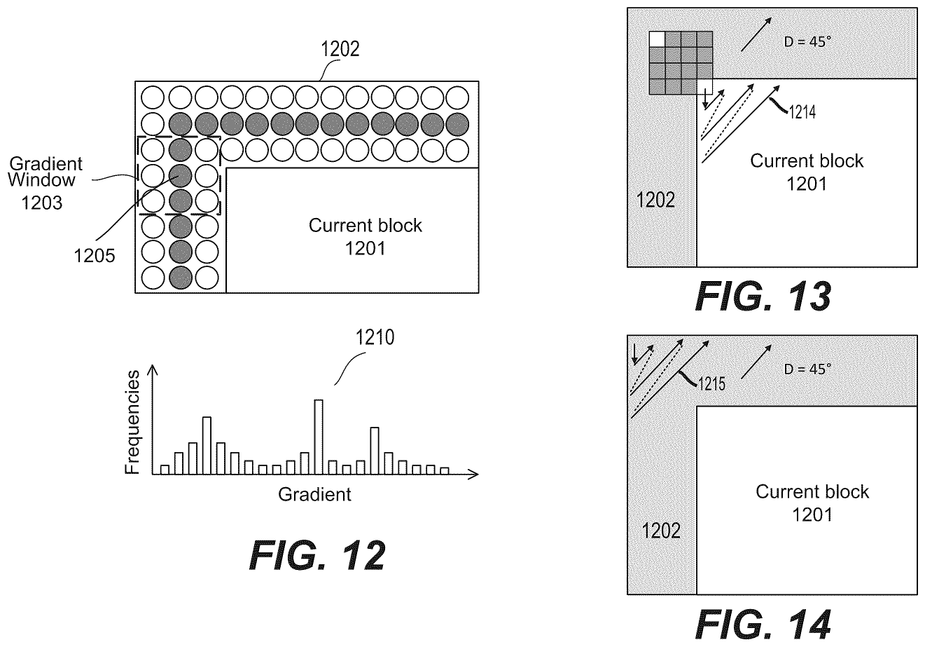

In an example, a current template of the current block includes reconstructed samples that neighbor the current block, and the reconstructed information of the current block includes gradient information of the current template of the current block. To adapt prediction to local texture, the gradient information may be derived from the current template neighboring the current block, e.g., via a Sobel filter and histogram of gradients described in FIG. 12, and a selection is made between the first and second shape sets based on a dominant direction D, including predefined angular ranges encompassing 90° for the first set and 45° for the second set.

In an example, the gradient information of the current template is determined by applying a filter such as a Sobel filter, a variation of the Sobel filter, and/or the like to multiple reconstructed samples in the reconstructed samples, such as shown in FIG. 12. The determined gradient information is employed to determine which variation of the square filter shape is used, which variation of the horizonal filter shape is used, or which variation of the vertical filter shape is used.

FIG. 12 shows an example of determining gradient information of a template (1202) of a current block (1201) in a current picture. The template (1202) includes reconstructed samples in the current picture that neighbor the current block (1201). The current block (1201) is predicted using the extrapolation filter. The gradient information of the current template (1202) may be determined by applying filters (e.g., horizontal and vertical Sobel filters) on samples in the template (1202) around the current block (1201). The template (1202) may have any suitable width and height and any suitable shape. In the example shown in FIG. 12, the template has a width of 3 samples. In an example, samples (marked in gray) in the middle line of the template (1202) are involved in the gradient information computation. Referring to FIG. 12, a window (1203) around a sample (1205) is used to determine a gradient associated with the sample (1205). The window (1203) may have any suitable size, such as a size of 3×3. The sample (1205) is in the center of the window (1203). In some examples, the sample (1205) is in an edge of the window (1203).

A horizontal gradient and a vertical gradient may be obtained using, for example, horizontal and vertical Sobel filters, respectively. Gradient information such as a direction or an orientation associated with the sample (1205) may be obtained from the horizontal gradient and the vertical gradient associated with the sample (1205). A histogram of gradients (HoG) (1210) of the template (1202) is obtained. The horizontal axis indicates the gradient information such as a plurality of gradients of the current template (1202). For example, each of the plurality of gradients is associated with a sample in the middle line of the template (1202) such as the sample (1205), and may be obtained from the horizontal gradient and the vertical gradient obtained from the respective sample in the middle line of the template (1202). In an example, each of the plurality of gradients corresponds to a direction derived from the horizontal gradient and the vertical gradient. The vertical axis of the HoG indicates the frequencies that the respective directions occur in the template (1202). In an example, referring to the HoG in FIG. 12, the gradient information of the current template (1202) indicates frequencies of occurrences of the plurality of gradients of the current template (1202). The set of filter shapes (e.g., the first set or the second set) is selected in the plurality of sets of filter shapes based on a direction corresponding to one of the plurality of gradients that has the largest frequency of the frequencies of occurrences. This direction is the most dominate direction (also interchangeably referred to as the dominated direction) and is denoted as D.

In an example, the HoG of the template (1202) is derived and the most dominate direction D is used to determine the filter shape of the extrapolation filter that is used to predict the current block (1201).

In an example, the most dominate direction D is used to determine which set of filter shapes is used, e.g., whether the first set of filter shapes or the second set of filter shapes is used.

In an example, when the direction (e.g., the dominated direction D) is within a first pre-defined range of (D₀ₘᵢₙ, D₀ₘₐₓ), the first set of filter shapes (e.g., S₀, H₀, and V₀) is selected as the set of filter shapes. The first pre-defined range includes an angle 90°. For example, when the dominated direction D falls within the pre-defined range of (D₀ₘᵢₙ, D₀ₘₐₓ), then S₀ is used. For example, the dominated direction D equals 90°, and falls within the range of 75°-135° where D₀ₘᵢₙ=75°, and D₀ₘₐₓ=135°, then S₀ is applied to generate the prediction signal.

When the direction (e.g., the dominated direction D) is within a second pre-defined range of (D₁ₘᵢₙ, D₁ₘₐₓ), the second set of filter shapes (e.g., S₁, H₁, and V₁) is selected as the set of filter shapes. The second pre-defined range includes an angle 45°. For example, when the dominated direction D falls within the pre-defined range of (D₁ₘᵢₙ, D₁ₘₐₓ), then the square filter S₁ is used. For example, the dominated direction D equals to 45°, and falls within the range of 15°-75° where D₁ₘᵢₙ=15°, and D₁ₘₐₓ=75°, then S₁ is applied to generate the prediction signal.

In some example, similar ideas are applied to the selection of the horizontal filter shape (H₀ or H₁) and the vertical filter shape (V₀ or V₁). The ranges (D₀ₘᵢₙ, D₀ₘₐₓ) and/or (D₁ₘᵢₙ, D₁ₘₐₓ) may be different from the ranges used in the selection of S₀ or S₁.

In an aspect, a specific filter shape (e.g., the square filter shape, the horizontal filter shape, or the vertical filter shape) is excluded (e.g., is normatively excluded) based on the gradient information. In some examples, shapes misaligned with the dominant direction are normatively excluded (e.g., excluding vertical shapes when the dominant direction is near the horizontal direction), which reduces signaling burden for the remaining shapes.

In some examples, when the specific filter is normatively excluded, second behavior of the decoder with the specific filter being excluded may be different from first behavior of the decoder without the specific filter being excluded. Thus, the second behavior of the decoder with the specific filter being excluded is consistent with the new change (e.g., exclusion of the specific filter). Accordingly, when the specific filter is normatively excluded, the decoder uses less bits to determine the remaining filter shapes when the encoder uses less bits to indicate the remaining filter shapes.

In an example, the selected set of filter shapes includes multiple filter shapes. When the direction is within a range, one of the multiple filter shapes is excluded from the selected set of filter shapes, and the multiple filter shapes include the one of the multiple filter shapes that is excluded and remaining filter shapes. The current sample in the current block is predicted based on the remaining filter shapes and using the extrapolated filter-based intra prediction. For example, when the dominant direction D is within a small range including the horizontal direction, the vertical filter is disallowed or excluded. Thus, if the selected set of filter shapes is the first set of filter shapes, V₀ is excluded. If the selected set of filter shapes is the second set of filter shapes, V₁ is excluded. In an example, the horizontal direction is from left to right (i.e., 180°). In an example, the horizontal direction is from right to left (i.e.) 0°. Similarly, when the dominant direction D is within a small range including the vertical direction, the horizontal filter is disallowed or excluded. Thus, if the selected set of filter shapes is the first set of filter shapes, H₀ is excluded. If the selected set of filter shapes is the second set of filter shapes, H₁ is excluded. In an example, the vertical direction is from bottom to up (i.e., 90°). In an example, the horizontal direction is from up to bottom (i.e.) 270°.

In an example, the number of allowed filter shapes is reduced, and thus the syntax indicating the used filter is binarized with less bins to save the bits in the bitstream. In an example, the coded information includes the syntax (e.g., a syntax element) indicating which filter shape in the remaining filter shapes is to be used in the extrapolated filter-based intra prediction. For example, without exclusion, the selected set of filters include 3 shapes (e.g., S₁, H₁, and V₁), and 2 bins are used to indicate which of the 3 shapes is selected. If H₁ is excluded, then the remaining filter shapes have 2 shapes, and only 1 bin is used to indicate which of the 2 remaining shapes is selected.

In an example, the reconstructed information of the current block includes one or more of (i) a shape and (ii) a size of the current block.

In some examples, prediction and model-learning scan orders are adapted to the gradient direction (e.g., counter-diagonal for approximately) 45° to improve accuracy such as shown in FIGS. 13-14.

In an example, samples in the current block are predicted based on the selected set of filter shapes and a scanning order and using the extrapolated filter-based intra prediction, such as shown in FIG. 13. The samples in the current block include the current sample, and the scanning order is based on the gradient information.

FIG. 13 shows an example of an adaptive scan order (1214) based on the derived gradient information in the template (1202) of the current block (1201) according to an aspect of the disclosure. In an example, when the dominant direction D derived from the template area (1202) is within a small range near 45° or is 45°, the scan order (1214) is from the top-left position to the bottom-right position of the current block (1201) with the counter-diagonal order (1214), as shown in FIG. 13.

In an example, a filter model for the extrapolated filter-based intra prediction is obtained based on a scanning order (1215) of the reconstructed samples in the current template (1202), such as shown in FIG. 14. The scanning order (1215) is based on the gradient information.

FIG. 14 shows an example of the adaptive scanning order (1215) that is used to determine the filter model according to an aspect of the disclosure. In an aspect, when learning the filter model, for example, determining the filter coefficients of the extrapolation filter, the scanning order used to scan the input samples is adaptively changed based on the gradient information of the template area (1202).

In an example, when the dominant direction D derived from the template area (1202) is within a small range near 45° or is 45°, the scan order (1215) is changed from a raster scan to a diagonal order (1215), as shown in FIG. 14. The scan order (1215) is also referred to as an input order or an input scanning order.

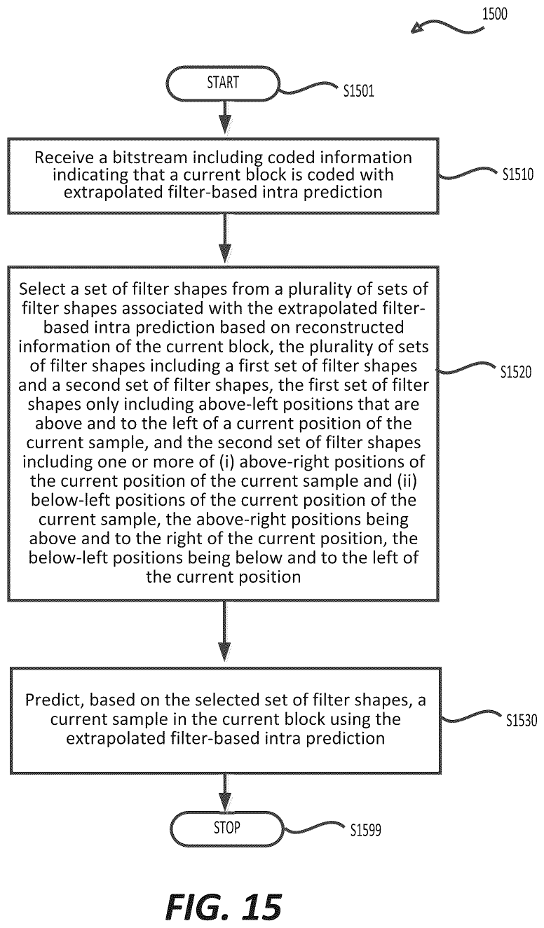

FIG. 15 shows a flow chart outlining a process (1500) according to an aspect of the disclosure. The process (1500) may be used in an apparatus, such as a video decoder. In various aspects, the process (1500) is executed by processing circuitry, such as the processing circuitry that performs functions of the video decoder (110), the processing circuitry that performs functions of the video decoder (210), and the like. In some aspects, the process (1500) is implemented in software instructions, thus when the processing circuitry executes the software instructions, the processing circuitry performs the process (1500). The process starts at (S1501) and proceeds to (S1510).

At (S1510), a bitstream including coded information indicating that a current block is coded with extrapolated filter-based intra prediction is received.

At (S1520), a set of filter shapes is selected from a plurality of sets of filter shapes associated with the extrapolated filter-based intra prediction based on reconstructed information of the current block. The plurality of sets of filter shapes includes a first set of filter shapes (e.g., the filter shapes (501)-(503) shown in FIG. 5) and a second set of filter shapes (e.g., the filter shapes (1101)-(1103) shown in FIG. 11).

In an example, the first set of filter shapes only includes above-left positions that are above and to the left of a current position of the current sample, such as shown in FIG. 5. In an example, the second set of filter shapes includes one or more of (i) above-right positions of the current position of the current sample and (ii) below-left positions of the current position of the current sample, such as shown in FIG. 11. The above-right positions are above and to the right of the current position, and the below-left positions are below and to the left of the current position.

In an example, a current template of the current block includes reconstructed samples that neighbor the current block, and the reconstructed information of the current block includes gradient information of the current template of the current block.

In an example, the gradient information of the current template is determined by applying a filter to multiple reconstructed samples in the reconstructed samples.

In an example, the gradient information of the current template indicates frequencies of occurrences of a plurality of gradients of the current template. The set of filter shapes is selected in the plurality of sets of filter shapes based on a direction corresponding to one of the plurality of gradients that has the largest frequency of the frequencies of occurrences.

In an example, when the direction is within a first pre-defined range of (D₀ₘᵢₙ, D₀ₘₐₓ), the first set of filter shapes is selected as the set of filter shapes. The first pre-defined range includes 90°. When the direction is within a second pre-defined range of (D₁ₘᵢₙ, D₁ₘₐₓ), the second set of filter shapes is selected as the set of filter shapes. The second pre-defined range includes 45°.

In an example, the reconstructed information of the current block includes one or more of (i) a shape and (ii) a size of the current block.

At (S1530), a current sample in the current block is predicted based on the selected set of filter shapes and using the extrapolated filter-based intra prediction.

In an example, the selected set of filter shapes includes multiple filter shapes. The coded information includes a syntax element indicating which filter shape in the multiple filter shapes is to be used in the extrapolated filter-based intra prediction. The current sample in the current block is predicted based on the filter shape in the multiple filter shapes of the selected set of filter shapes and using the extrapolated filter-based intra prediction.

In an example, samples in the current block are predicted using the extrapolated filter-based intra prediction and based on the selected set of filter shapes and a scanning order. The samples in the current block include the current sample. The scanning order is based on the gradient information.

Then, the process proceeds to (S1599) and terminates.

The process (1500) may be suitably adapted. Step(s) in the process (1500) may be modified and/or omitted. Additional step(s) may be added. Any suitable order of implementation may be used.

In an example, the selected set of filter shapes includes multiple filter shapes. When the direction is within a range, one of the multiple filter shapes is excluded from the selected set of filter shapes, and the multiple filter shapes includes the one of the multiple filter shapes that is excluded and remaining filter shapes. The current sample in the current block is predicted based on the remaining filter shapes and using the extrapolated filter-based intra prediction.

In an example, the coded information includes a syntax element indicating which filter shape in the remaining filter shapes is to be used in the extrapolated filter-based intra prediction.

In an example, a filter model for the extrapolated filter-based intra prediction is obtained based on a scanning order of the reconstructed samples in the current template. The scanning order is based on the gradient information.

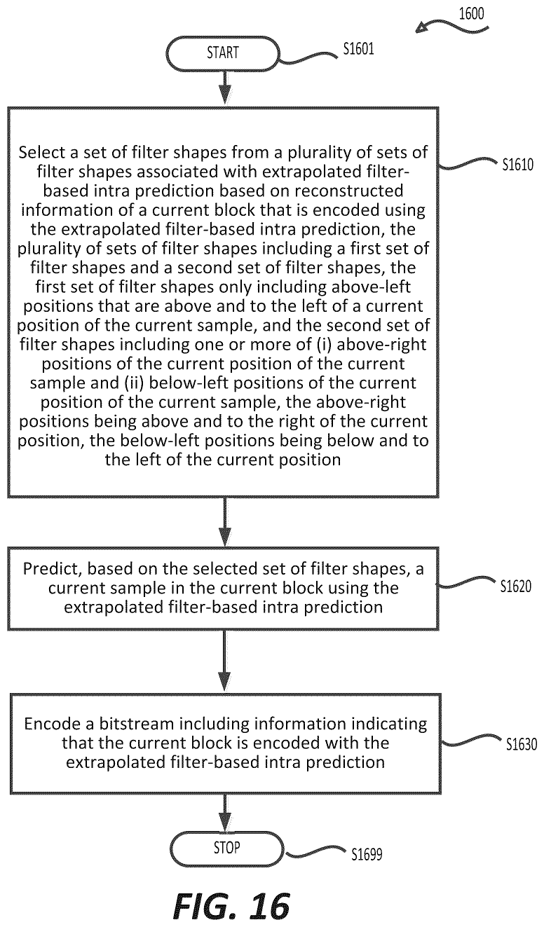

FIG. 16 shows a flow chart outlining a process (1600) according to an aspect of the disclosure. The process (1600) may be used in an apparatus, such as a video encoder. The video encoder is configured, for example, to encode one or more meshes. In various aspects, the process (1600) is executed by processing circuitry, such as the processing circuitry that performs functions of the video encoder (103), the processing circuitry that performs functions of the video encoder (303), the mesh encoder, and/or the like. In some aspects, the process (1600) is implemented in software instructions, thus when the processing circuitry executes the software instructions, the processing circuitry performs the process (1600). The process starts at (S1601) and proceeds to (S1610).

At (S1610), a set of filter shapes is selected from a plurality of sets of filter shapes associated with extrapolated filter-based intra prediction based on reconstructed information of a current block that is encoded using the extrapolated filter-based intra prediction. The plurality of sets of filter shapes includes a first set of filter shapes and a second set of filter shapes. In an example, the first set of filter shapes only includes above-left positions that are above and to the left of a current position of the current sample. The second set of filter shapes includes one or more of (i) above-right positions of the current position of the current sample and (ii) below-left positions of the current position of the current sample. The above-right positions are above and to the right of the current position, and the below-left positions are below and to the left of the current position.

At (S1620), a current sample in the current block is predicted, based on the selected set of filter shapes, using the extrapolated filter-based intra prediction.

At (S1630), a bitstream including information indicating that the current block is encoded with the extrapolated filter-based intra prediction is encoded.

Then, the process proceeds to (S1699) and terminates.

The process (1600) may be suitably adapted. Step(s) in the process (1600) may be modified and/or omitted. Additional step(s) may be added. Any suitable order of implementation may be used.

In an aspect, a non-transitory computer-readable storage medium storing instructions which when executed by a processor cause the processor to perform a method of encoding a bitstream. The method includes: selecting a set of filter shapes from a plurality of sets of filter shapes associated with extrapolated filter-based intra prediction based on reconstructed information of a current block that is encoded using the extrapolated filter-based intra prediction; predicting, based on the selected set of filter shapes, a current sample in the current block using the extrapolated filter-based intra prediction; encoding the bitstream including information indicating that the current block is encoded with the extrapolated filter-based intra prediction; and transmitting the bitstream. The plurality of sets of filter shapes includes a first set of filter shapes and a second set of filter shapes. In an example, the first set of filter shapes only includes above-left positions that are above and to the left of a current position of the current sample. The second set of filter shapes includes one or more of (i) above-right positions of the current position of the current sample and (ii) below-left positions of the current position of the current sample. The above-right positions are above and to the right of the current position, and the below-left positions are below and to the left of the current position.

An aspect of the disclosure provides methods, apparatuses, and non-transitory storage medium for video encoding and decoding that perform extrapolated filter-based intra prediction using reconstructed information. A decoder or encoder selects, for a current block, a set of filter shapes from among a first set that uses only above-left inputs and a second set that includes one or more above-right and/or below-left inputs. The selection is based on the reconstructed information, such as gradient information of a template of reconstructed neighboring samples of the current block. The selected shapes are used to predict current samples in the current block, with shape variations (e.g., S₀ vs. S₁) determined implicitly from the reconstructed information. In some examples, shapes inconsistent with the dominant gradient direction are excluded to reduce syntax signaling.

In related technologies, the encoder selects a filter model from 9 combinations formed by the three filter shapes in the first set of filter shapes shown in FIG. 5 and the three template shapes shown in FIG. 6. A syntax element such as an index may be signaled to indicate the selected combination with a specific filter shape (e.g., (501)) and a specific template shape (e.g., (601)). According to an aspect of the disclosure, a number of the filter shapes increases, for example, is doubled to include the three filter shapes in the second set of filter shapes shown in FIG. 11. This second set increases a filter shape diversity and doubles the number of available filter shapes available to the encoder for each template shape, thus increasing the exploration space for leaning the extrapolation filter model.

In some examples, technical advantages include an increased model diversity that captures local texture more accurately. By adding the second set of filter shapes, the encoder may evaluate both the above-left-only filter shapes (501)-(503) and the filter shapes (1101)-(1103) that include the above-right and/or the below-left inputs, improving adaptability to local edge orientations and textures captured, for example, in the reconstructed samples in the current template. This expanded diversity allows the learned filter model to fit the local gradient structure more closely, yielding a more accurate prediction signal of the current block, and thus reducing the residual signal.

Further, the encoder-side gains are achieved with minimal computational overhead. In some examples, at the encoder side, the encoder has a larger model set, and thus improving the chance of selecting a better-fit filter model and reducing a prediction error. This benefit may be achieved without imposing corresponding complexity at the decoder beyond an inference step. In an example, the encoder decides between the first versus second filter-shape set (e.g., using the reconstructed information such as the gradient information, a block size, a block shape, prediction modes in the template of the current block, and/or the like), and the encoder and the decoder evaluate 9 combinations formed by the three selected filter shapes (e.g., either the first set in FIG. 5 or the second set in FIG. 11) and the three template shapes shown in FIG. 6, thus a number of evaluations is the same as the number of evaluations in the related technology that does not include the second sets of filter shapes. Accordingly, the exploration space for the extrapolation filter is doubled by considering the second set of shapes, however, the per-combination scoring count remains nine, and thus there is no or minor increase of the encoder complexity and the decoder complexity.

The set selection (the first set vs. the second set) is based on the reconstructed information, such as template gradient information derived from filters such as Sobel. This provides a robust, data-driven mechanism that aligns the set selection with the dominant local direction D, which steers the encoder toward filter models that may better match underlying content and reduces residuals.

As described in the disclosure, in some examples, the filter “family” (whether the filter has the square shape, the horizontal shape, or the vertical shape) is signaled, and the choice between S₀/S₁ (or H₀/H₁, V₀/V₁) variation is made implicitly from the reconstructed information, thus removing the need to explicitly signal the selection between the first set and the second set (e.g., whether the filter shape is S₀ or S₁) and preserving decoder simplicity. When the dominant direction is near a principal axis, misaligned shapes may be normatively excluded, reducing the number of bins needed to signal the remaining choices and saving bits without sacrificing prediction quality. These mechanisms maintain or improve coding efficiency alongside the expanded model space.

Compared to the related technologies that use the fixed nine combinations of the filter shapes and template shapes, the methods that further include the second set shown in FIG. 11 result in a larger model space for the filter model by adding the second set of filter shapes while retaining the same nine evaluations per block, thus improving prediction accuracy and reducing residuals with minimal additional computation and no extra signaling burden. This may result in better rate-distortion performance through lower residual energy. Further, signaling savings via normative exclusions may also be achieved.

Methods, aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium.

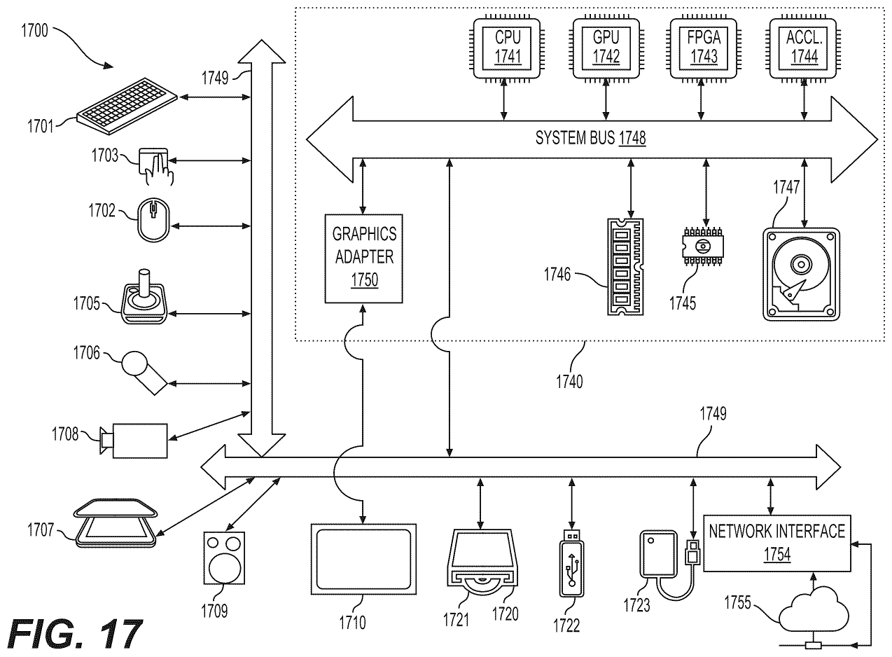

The techniques described above, may be implemented as computer software using computer-readable instructions and physically stored in one or more computer-readable media. For example, FIG. 17 shows a computer system (1700) suitable for implementing certain aspects of the disclosed subject matter.

The computer software may be coded using any suitable machine code or computer language, that may be subject to assembly, compilation, linking, or like mechanisms to create code comprising instructions that may be executed directly, or through interpretation, micro-code execution, and the like, by one or more computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 17 for computer system (1700) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1700).

Computer system (1700) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1701), mouse (1702), trackpad (1703), touch screen (1710), data-glove (not shown), joystick (1705), microphone (1706), scanner (1707), camera (1708).

Computer system (1700) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1710), data-glove (not shown), or joystick (1705), but there may also be tactile feedback devices that do not serve as input devices), audio output devices (such as: speakers (1709), headphones (not depicted)), visual output devices (such as screens (1710) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1700) may also include human accessible storage devices and their associated media such as optical media including CD/DVD ROM/RW (1720) with CD/DVD or the like media (1721), thumb-drive (1722), removable hard drive or solid state drive (1723), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1700) may also include an interface (1754) to one or more communication networks (1755). Networks may for example be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1749) (such as, for example USB ports of the computer system (1700)); others are commonly integrated into the core of the computer system (1700) by attachment to a system bus as described below (for example Ethernet interface into a PC computer system or cellular network interface into a smartphone computer system). Using any of these networks, computer system (1700) may communicate with other entities. Such communication may be uni-directional, receive only (for example, broadcast TV), uni-directional send-only (for example CANbus to certain CANbus devices), or bi-directional, for example to other computer systems using local or wide area digital networks. Certain protocols and protocol stacks may be used on each of those networks and network interfaces as described above.

Aforementioned human interface devices, human-accessible storage devices, and network interfaces may be attached to a core (1740) of the computer system (1700).

The core (1740) may include one or more Central Processing Units (CPU) (1741), Graphics Processing Units (GPU) (1742), specialized programmable processing units in the form of Field Programmable Gate Areas (FPGA) (1743), hardware accelerators for certain tasks (1744), graphics adapters (1750), and so forth. These devices, along with Read-only memory (ROM) (1745), Random-access memory (1746), internal mass storage such as internal non-user accessible hard drives, SSDs, and the like (1747), may be connected through a system bus (1748). In some computer systems, the system bus (1748) may be accessible in the form of one or more physical plugs to enable extensions by additional CPUs, GPU, and the like. The peripheral devices may be attached either directly to the core's system bus (1748), or through a peripheral bus (1749). In an example, the screen (1710) may be connected to the graphics adapter (1750). Architectures for a peripheral bus include PCI, USB, and the like.

CPUs (1741), GPUs (1742), FPGAs (1743), and accelerators (1744) may execute certain instructions that, in combination, may make up the aforementioned computer code. That computer code may be stored in ROM (1745) or RAM (1746). Transitional data may also be stored in RAM (1746), whereas permanent data may be stored for example, in the internal mass storage (1747). Fast storage and retrieve to any of the memory devices may be enabled through the use of cache memory, that may be closely associated with one or more CPU (1741), GPU (1742), mass storage (1747), ROM (1745), RAM (1746), and the like.

The computer readable media may have computer code thereon for performing various computer-implemented operations. The media and computer code may be those specially designed and constructed for the purposes of the present disclosure, or they may be of the kind well known and available to those skilled in the computer software arts.

As an example and not by way of limitation, the computer system having architecture (1700), and specifically the core (1740) may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core (1740) that are of non-transitory nature, such as core-internal mass storage (1747) or ROM (1745). The software implementing various aspects of the present disclosure may be stored in such devices and executed by core (1740). A computer-readable medium may include one or more memory devices or chips, according to particular needs. The software may cause the core (1740) and specifically the processors therein (including CPU, GPU, FPGA, and the like) to execute particular processes or particular parts of particular processes described herein, including defining data structures stored in RAM (1746) and modifying such data structures according to the processes defined by the software. In addition or as an alternative, the computer system may provide functionality as a result of logic hardwired or otherwise embodied in a circuit (for example: accelerator (1744)), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method for video decoding, the method including: receiving a bitstream including coded information indicating that a current block is coded with extrapolated filter-based intra prediction; selecting a set of filter shapes from a plurality of sets of filter shapes associated with the extrapolated filter-based intra prediction based on reconstructed information of the current block, the plurality of sets of filter shapes including a first set of filter shapes and a second set of filter shapes; predicting, based on the selected set of filter shapes, a current sample in the current block using the extrapolated filter-based intra prediction, wherein the first set of filter shapes only includes above-left positions that are above and to the left of a current position of the current sample; and the second set of filter shapes includes one or more of (i) above-right positions of the current position of the current sample and (ii) below-left positions of the current position of the current sample, the above-right positions being above and to the right of the current position, the below-left positions being below and to the left of the current position.
(2) The method of feature (1), in which a current template of the current block includes reconstructed samples that neighbor the current block, and the reconstructed information of the current block includes gradient information of the current template of the current block.
(3) The method of feature (2), in which the selecting further comprises: determining the gradient information of the current template by applying a filter to multiple reconstructed samples in the reconstructed samples.
(4) The method of feature (3), in which the gradient information of the current template indicates frequencies of occurrences of a plurality of gradients of the current template; and the selecting includes selecting the set of filter shapes in the plurality of sets of filter shapes based on a direction corresponding to one of the plurality of gradients that has the largest frequency of the frequencies of occurrences.
(5) The method of feature (4), in which the selecting comprises: when the direction is within a first pre-defined range of (D₀ₘᵢₙ, D₀ₘₐₓ), selecting the first set of filter shapes as the set of filter shapes, the first pre-defined range including 90°; and when the direction is within a second pre-defined range of (D₁ₘᵢₙ, D₁ₘₐₓ), selecting the second set of filter shapes as the set of filter shapes, the second pre-defined range including 45°.
(6) The method of feature (4), in which the selected set of filter shapes includes multiple filter shapes; when the direction is within a range, one of the multiple filter shapes is excluded from the selected set of filter shapes, the multiple filter shapes including the one of the multiple filter shapes that is excluded and remaining filter shapes; and the predicting includes predicting, based on the remaining filter shapes, the current sample in the current block using the extrapolated filter-based intra prediction.
(7) The method of feature (6), in which the coded information includes a syntax element indicating which filter shape in the remaining filter shapes is to be used in the extrapolated filter-based intra prediction.
(8) The method of feature (1), in which the reconstructed information of the current block includes one or more of (i) a shape and (ii) a size of the current block.
(9) The method of feature (1), in which the selected set of filter shapes includes multiple filter shapes; the coded information includes a syntax element indicating which filter shape in the multiple filter shapes is to be used in the extrapolated filter-based intra prediction; and the predicting includes predicting, based on the filter shape in the multiple filter shapes of the selected set of filter shapes, the current sample in the current block using the extrapolated filter-based intra prediction.
(10) The method of any of features (2) to (7), in which the predicting includes predicting, based on the selected set of filter shapes and a scanning order, samples in the current block using the extrapolated filter-based intra prediction, the samples in the current block including the current sample, the scanning order being based on the gradient information.
(11) The method of any of features (2) to (7), further comprising: obtaining a filter model for the extrapolated filter-based intra prediction based on a scanning order of the reconstructed samples in the current template, the scanning order being based on the gradient information.
(12) A method for video encoding, the method including: selecting a set of filter shapes from a plurality of sets of filter shapes associated with extrapolated filter-based intra prediction based on reconstructed information of a current block that is encoded using the extrapolated filter-based intra prediction, the plurality of sets of filter shapes including a first set of filter shapes and a second set of filter shapes; predicting, based on the selected set of filter shapes, a current sample in the current block using the extrapolated filter-based intra prediction; and encoding a bitstream including information indicating that the current block is encoded with the extrapolated filter-based intra prediction, in which the first set of filter shapes only includes above-left positions that are above and to the left of a current position of the current sample; and the second set of filter shapes includes one or more of (i) above-right positions of the current position of the current sample and (ii) below-left positions of the current position of the current sample, the above-right positions being above and to the right of the current position, the below-left positions being below and to the left of the current position.
(13) The method of feature (12), in which a current template of the current block includes reconstructed samples that neighbor the current block, and the reconstructed information of the current block includes gradient information of the current template of the current block.
(14) The method of feature (13), in which the selecting further comprises: determining the gradient information of the current template by applying a filter to multiple reconstructed samples in the reconstructed samples.
(15) The method of feature (14), in which the gradient information of the current template indicates frequencies of occurrences of a plurality of gradients of the current template; and the selecting includes selecting the set of filter shapes in the plurality of sets of filter shapes based on a direction corresponding to one of the plurality of gradients that has the largest frequency of the frequencies of occurrences.
(16) The method of feature (15), in which the selecting comprises: when the direction is within a first pre-defined range of (D₀ₘᵢₙ, D₀ₘₐₓ), selecting the first set of filter shapes as the set of filter shapes, the first pre-defined range including 90°; and when the direction is within a second pre-defined range of (D₁ₘᵢₙ, D₁ₘₐₓ), selecting the second set of filter shapes as the set of filter shapes, the second pre-defined range including 45°.
(17) The method of feature (15), in which the selected set of filter shapes includes multiple filter shapes; when the direction is within a range, one of the multiple filter shapes is excluded from the selected set of filter shapes, the multiple filter shapes including the one of the multiple filter shapes that is excluded and remaining filter shapes; and the predicting includes predicting, based on the remaining filter shapes, the current sample in the current block using the extrapolated filter-based intra prediction.
(18) The method of feature (12), in which the reconstructed information of the current block includes one or more of (i) a shape and (ii) a size of the current block.
(19) A non-transitory computer-readable storage medium storing instructions which when executed by a processor cause the processor to perform a method of encoding a bitstream including: selecting a set of filter shapes from a plurality of sets of filter shapes associated with extrapolated filter-based intra prediction based on reconstructed information of a current block that is encoded using the extrapolated filter-based intra prediction, the plurality of sets of filter shapes including a first set of filter shapes and a second set of filter shapes; predicting, based on the selected set of filter shapes, a current sample in the current block using the extrapolated filter-based intra prediction; encoding the bitstream including information indicating that the current block is encoded with the extrapolated filter-based intra prediction; and transmitting the bitstream, in which the first set of filter shapes only includes above-left positions that are above and to the left of a current position of the current sample; and the second set of filter shapes includes one or more of (i) above-right positions of the current position of the current sample and (ii) below-left positions of the current position of the current sample, the above-right positions being above and to the right of the current position, the below-left positions being below and to the left of the current position.
(20) The method of feature (19), in which a current template of the current block includes reconstructed samples that neighbor the current block, and the reconstructed information of the current block includes gradient information of the current template of the current block.
(21) An apparatus of video decoding, including processing circuitry that is configured to perform the method of any of features (1) to (11).
(22) An apparatus of video encoding, including processing circuitry that is configured to perform the method of any of features (12) to (18).
(23) A non-transitory computer-readable storage medium storing instructions which when executed by at least one processor cause the at least one processor to perform the method of any of features (1) to (18).

What is claimed is:

1. A method for video decoding, the method comprising:
receiving a bitstream including coded information indicating that a current block is coded with extrapolated filter-based intra prediction;
selecting a set of filter shapes from a plurality of sets of filter shapes associated with the extrapolated filter-based intra prediction based on reconstructed information of the current block, the plurality of sets of filter shapes including a first set of filter shapes and a second set of filter shapes;
predicting, based on the selected set of filter shapes, a current sample in the current block using the extrapolated filter-based intra prediction, wherein
the first set of filter shapes only includes above-left positions that are above and to the left of a current position of the current sample; and
the second set of filter shapes includes one or more of (i) above-right positions of the current position of the current sample and (ii) below-left positions of the current position of the current sample, the above-right positions being above and to the right of the current position, the below-left positions being below and to the left of the current position.

2. The method of claim 1, wherein a current template of the current block includes reconstructed samples that neighbor the current block, and the reconstructed information of the current block includes gradient information of the current template of the current block.

3. The method of claim 2, wherein the selecting further comprises:
determining the gradient information of the current template by applying a filter to multiple reconstructed samples in the reconstructed samples.

4. The method of claim 3, wherein
the gradient information of the current template indicates frequencies of occurrences of a plurality of gradients of the current template; and
the selecting includes selecting the set of filter shapes in the plurality of sets of filter shapes based on a direction corresponding to one of the plurality of gradients that has the largest frequency of the frequencies of occurrences.

5. The method of claim 4, wherein the selecting comprises:
when the direction is within a first pre-defined range of (D₀ₘᵢₙ, D₀ₘₐₓ), selecting the first set of filter shapes as the set of filter shapes, the first pre-defined range including 90°; and
when the direction is within a second pre-defined range of (D₁ₘᵢₙ, D₁ₘₐₓ), selecting the second set of filter shapes as the set of filter shapes, the second pre-defined range including 45°.

6. The method of claim 4, wherein
the selected set of filter shapes includes multiple filter shapes;
when the direction is within a range, one of the multiple filter shapes is excluded from the selected set of filter shapes, the multiple filter shapes including the one of the multiple filter shapes that is excluded and remaining filter shapes; and
the predicting includes predicting, based on the remaining filter shapes, the current sample in the current block using the extrapolated filter-based intra prediction.

7. The method of claim 6, wherein
the coded information includes a syntax element indicating which filter shape in the remaining filter shapes is to be used in the extrapolated filter-based intra prediction.

8. The method of claim 1, wherein the reconstructed information of the current block includes one or more of (i) a shape and (ii) a size of the current block.

9. The method of claim 1, wherein
the selected set of filter shapes includes multiple filter shapes;
the coded information includes a syntax element indicating which filter shape in the multiple filter shapes is to be used in the extrapolated filter-based intra prediction; and
the predicting includes predicting, based on the filter shape in the multiple filter shapes of the selected set of filter shapes, the current sample in the current block using the extrapolated filter-based intra prediction.

10. The method of claim 2, wherein the predicting includes predicting, based on the selected set of filter shapes and a scanning order, samples in the current block using the extrapolated filter-based intra prediction, the samples in the current block including the current sample, the scanning order being based on the gradient information.

11. The method of claim 2, further comprising:
obtaining a filter model for the extrapolated filter-based intra prediction based on a scanning order of the reconstructed samples in the current template, the scanning order being based on the gradient information.

12. A method for video encoding, the method comprising:
selecting a set of filter shapes from a plurality of sets of filter shapes associated with extrapolated filter-based intra prediction based on reconstructed information of a current block that is encoded using the extrapolated filter-based intra prediction, the plurality of sets of filter shapes including a first set of filter shapes and a second set of filter shapes;
predicting, based on the selected set of filter shapes, a current sample in the current block using the extrapolated filter-based intra prediction; and
encoding a bitstream including information indicating that the current block is encoded with the extrapolated filter-based intra prediction, wherein
the first set of filter shapes only includes above-left positions that are above and to the left of a current position of the current sample; and
the second set of filter shapes includes one or more of (i) above-right positions of the current position of the current sample and (ii) below-left positions of the current position of the current sample, the above-right positions being above and to the right of the current position, the below-left positions being below and to the left of the current position.

13. The method of claim 12, wherein a current template of the current block includes reconstructed samples that neighbor the current block, and the reconstructed information of the current block includes gradient information of the current template of the current block.

14. The method of claim 13, wherein the selecting further comprises:
determining the gradient information of the current template by applying a filter to multiple reconstructed samples in the reconstructed samples.

15. The method of claim 14, wherein
the gradient information of the current template indicates frequencies of occurrences of a plurality of gradients of the current template; and
the selecting includes selecting the set of filter shapes in the plurality of sets of filter shapes based on a direction corresponding to one of the plurality of gradients that has the largest frequency of the frequencies of occurrences.

16. The method of claim 15, wherein the selecting comprises:
when the direction is within a first pre-defined range of (D₀ₘᵢₙ, D₀ₘₐₓ), selecting the first set of filter shapes as the set of filter shapes, the first pre-defined range including 90°; and
when the direction is within a second pre-defined range of (D₁ₘᵢₙ, D₁ₘₐₓ), selecting the second set of filter shapes as the set of filter shapes, the second pre-defined range including 45°.

17. The method of claim 15, wherein
the selected set of filter shapes includes multiple filter shapes;
when the direction is within a range, one of the multiple filter shapes is excluded from the selected set of filter shapes, the multiple filter shapes including the one of the multiple filter shapes that is excluded and remaining filter shapes; and
the predicting includes predicting, based on the remaining filter shapes, the current sample in the current block using the extrapolated filter-based intra prediction.

18. The method of claim 12, wherein the reconstructed information of the current block includes one or more of (i) a shape and (ii) a size of the current block.

19. A non-transitory computer-readable storage medium storing instructions which when executed by a processor cause the processor to perform a method of encoding a bitstream comprising:
selecting a set of filter shapes from a plurality of sets of filter shapes associated with extrapolated filter-based intra prediction based on reconstructed information of a current block that is encoded using the extrapolated filter-based intra prediction, the plurality of sets of filter shapes including a first set of filter shapes and a second set of filter shapes;
predicting, based on the selected set of filter shapes, a current sample in the current block using the extrapolated filter-based intra prediction;
encoding the bitstream including information indicating that the current block is encoded with the extrapolated filter-based intra prediction; and
transmitting the bitstream, wherein
the first set of filter shapes only includes above-left positions that are above and to the left of a current position of the current sample; and
the second set of filter shapes includes one or more of (i) above-right positions of the current position of the current sample and (ii) below-left positions of the current position of the current sample, the above-right positions being above and to the right of the current position, the below-left positions being below and to the left of the current position.

20. The non-transitory computer-readable storage medium of claim 19, wherein a current template of the current block includes reconstructed samples that neighbor the current block, and the reconstructed information of the current block includes gradient information of the current template of the current block.
